(19) United States
(12) Patent Application Publication
(10) Pub. No.: US 2004/0151860 A1
(43) Pub. Date: Aug. 5, 2004

(54) Shopping and reference list apparatus

(76) Inventor: Titen C. Shah, Wheeling, IL (US)

Correspondence Address: JITEN C. SHAH, 516 CHERRYWOOD DRIVE, WHEELING, IL, 60090, US

(21) Appl. No.: 10/748,501

(22) Filed: Dec. 30, 2003

Related U.S. Application Data
(63) Continuation of application No. 60/437,562, filed on Jan. 3, 2003.

(51) Int. Cl. B32B 9/00

(52) U.S. Cl. 428/40.1; 428/343

(57) ABSTRACT

This invention pertains to a shopping and reference list. The shopping and reference list comprises of pad of pre-printed sheets of papers substantially aligned at the top and bound together with glue similar to that found in Post It™ or similar pads used in everyday life. The pre-printed sheet consists of an insignia, generally in a tabular format such that items in each category box or cell is generally organized in a manner corresponding to an isle/area of a grocery store. The pad can be mounted on a refrigerator and updated in real time. The list is removed from the pad when going for grocery shopping and wrapped around the user's wrist or the handle of the grocery cart allowing both hands to be free for shopping. The organization of the list allows the purchase of all the items from a particular isle without having to go back and forth.

### CROSS-REFERENCE TO RELATED APPLICATIONS

This application is a regular application of the Provisional Application filed by the same applicant, Serial No. 60/437,562, filed on Jan. 3, 2003.

### BACKGROUND OF THE INVENTION

A. Field of the Invention

This invention pertains to the field of planning, formatting, organizing, preparing, and using lists for easy reference and more particularly to planning, formatting, organizing, preparing, and using lists for purchasing groceries.

B. Description of Related Art

Visits to a grocery store are almost a once a week, if not more, chore for most households. These visits require planning and preparation. Lack of such planning and preparation can result in frustration borne out of missing to purchase items needed. Furthermore, an unorganized list can also result in going back and forth within a store, which can consume a lot of time.

In most cases the list is prepared by member(s) of the household prior to leaving for supermarket. This may or may not be done in consultation with other family members due to their lack of availability at the time the list is prepared. The list of items to be purchased is written down on a piece of paper. This list in most cases is not necessarily organized in any manner such as Dairy, Beverages, Meats, etc. to generally match the organization of the supermarket. Also the list may reflect only the list of items to be purchased as remembered by member(s) of the family present at that given time when the list is prepared.

Once at the supermarket, the list is repeatedly referenced and is placed back either in the cart or in the pocket or the purse while the shopper proceeds to purchase the item from the shelf/table in the store. The list is frequently misplaced in the grocery cart or a pocket or a purse; and in some instances lost altogether. This results in lost time and frustration looking for the list. Also since the list may not be organized by any classification, it results into several back and forth trips across the store, once again adding to the frustration and time.

Most current forms of shopping lists or a grocery lists involve preparation of list using a loose sheet of paper and writing down a list just around the time when ready to go shopping. This method generally results in an incomplete and unorganized list. Also referencing such a list is cumbersome in that, as previously mentioned, the list often is lost in the grocery cart or in the pocket of clothing or dropped on the floor while picking up items. Typically such a list requires it to be picked up for reference and put back down, either in the cart or in a pocket or crumpled in the hand while collecting or picking up items from the shelf. Sometime a shopper resorts to sticking the list in the mouth while picking up the merchandise sticking which can create a potential for unhygienic situation. This method also results in constant use of hands to reference the list again and again.

There are several approaches disclosed in the prior art for helping the user prepare a shopping list. U.S. Pat. No. 489,060 to Wilhelm describes an indicator sheet with indicator matter and a series of index wings; U.S. Pat. No. 1,729,916 to Vernon consists of a stiff back and paraffin with transparent covering that also includes a light colored opaque tissue bearing a list of needed articles; and U.S. Pat. No. 2,279,189 to Uhlir consists of a sheet of paper with indicator tabs.

Furthermore, various preprinted shopping lists and coupon pouches are also disclosed in the prior art. For example, U.S. Pat. No. 6,644,697 to Schinella discloses an integrated shopping list and coupon folder formed from a single shopping list sheet having tacky strips placed at the bottom edge and two sides of the sheet. To convert the shopping list sheet into an integrated shopping list and coupon folder, the completed shopping list sheet is peeled from a pad of such sheets and folded along a central fold line, such that the bottom tacky strip seals against itself and the side tacky strips seal against each other. Additionally, U.S. Pat. No. 5,350,197 to Schmidt discloses a shopping list sheet with a folded pouch at the bottom, open on two sides, for containing coupons. The coupon pouch in Schmidt is pre-formed using permanent adhesive. U.S. Pat. No. 4,954,003 to Shea discloses a coupon organizer with the ability to contain a shopping list. Shea's device comprises a ring binder with several permanent, clear plastic holding pockets, and the shopping list is merely a loose-leaf page in the binder.

None of the shopping lists disclosed in the prior art is easy and convenient to use. Thus it can be seen that a shopping and reference list sheet that can be wrapped around the user's wrist or the handle of a shopping cart, would be a clear and significant improvement over the prior art.

### SUMMARY OF THE INVENTION

The preferred embodiment of the invention provides a shopping list or a reference list that can be wrapped around the wrist of the user or the handle of a shopping cart for easy reference and convenience enabling the user to have both hands free for shopping purposes and eliminating the possibility that the list might be lost during the shopping activities. The invention further provides an ability to prepare a list by generic grouping of items per area/isle of a supermarket as offered by a pre-printed insignia for grocery shopping using a plain paper. The insignia can be customized to fit the store layout or as required by the user. The shopping and reference list of the present invention can be assembled into a pad which can be easily mounted on the refrigerator or on a similar surface by the use of pressure sensitive adhesive on the back side of the last sheet or by other means such as a magnetic strip, etc. The list provides continuing, real time updating ability in an organized manner as groceries are identified to be purchased. The list can be updated as and when an item is identified; and all needed items can be purchased during the next trip to the store without forgetting.

The invention comprises adequately sized sheets of paper. The front of the paper is pre-printed with an insignia in the form of a table so as to group items of groceries in a manner that they are generally located in a specific isle or area of a grocery store. Each section of the grouping on the list also has area to make entries of items that would generally be found within the said group. The insignia can be customized to meet needs of the user. The backside of each rectangular paper consists of a strip of pressure sensitive adhesive at the top end of the page. The invention comprise plurality of such sheets such that each sheet is attached to the subsequent sheet by means of pressure sensitive adhesive fastener strip applied at the top of each sheet. The last sheet with pressure sensitive adhesive strip is attached to a plain paper, without any adhesive. The plain paper can be removed such that the last sheet with the adhesive can be mounted on the refrigerator or other suitable surfaces either by means of the pressure sensitive adhesive strip or other means such as magnetic strip or velcro strips or other mechanical means. The magnetic sheet can be equipped with a writing tool such as a pencil, a pocket or a clip for coupons etc. so that a writing device is readily available and a place for coupon is also easily accessible. The backside of the last sheet is alternately used to provide instructions on how to use the shopping and reference list according to the present invention or for advertising purposes.

One form of note pad, amongst other, used in conjunction with the present invention is being marketed under the trademark “Post-It™” by Minnesota Mining and Manufacturing Company, St. Paul, Minn. Other note pads, similar in design, configuration and application can also be used with the present invention.

In another embodiment of the invention a food pyramid is displayed on the shopping list enabling the user in identifying foods that might help in realizing a balanced diet.

In yet another embodiment of the present invention, the shopping and reference list comprises material such as plastic that is updated with erasable ink and thus is re-usable.

While the above description contains many specifics to the example cited, these should not be construed as limitations on the scope of the invention, but rather as an exemplification of one of the preferred embodiment thereof. Many other variations are possible, for example use of the shopping and reference list for inventory verification where the user may update the item list while verifying the inventory. One example may be in a convenience store where inventory may be updated by isle where user can update the information on the list tied around the wrist.

Further objects and advantages of the present invention will become apparent from consideration of the drawings and ensuing description thereof.

### BRIEF DESCRIPTION OF THE DRAWINGS

FIG. 1A illustrates an example of a preprinted, organization form for shopping and reference according to the preferred embodiment of the present invention.

FIG. 1B illustrates an example of a food pyramid displaying balanced diet (based on Federal Citizen Information Center website at www.pueblo.gsa.gov)

FIG. 1C illustrates an example of the food pyramid of FIG. 1B superimposed on the shopping list of FIG. 1A according to the preferred embodiment of the present invention.

FIG. 2 depicts the side view of the 3M Post It™ Notes pad or similarly glued paper.

FIG. 3 shows the shopping and reference list pad attached to a refrigerator.

FIG. 4 illustrates the shopping and reference list in the form of a loop created by attaching the top glued end of the sheet with the bottom non-glued end of the sheet on the same side of the sheet according to an embodiment of the present invention.

FIG. 5 illustrates the shopping and reference list in the form of another loop created by attaching the top glued end of the sheet with the bottom non-glued end of the sheet on the opposite side of the sheet according to another embodiment of the present invention

FIG. 6 displays the shopping and reference list wrapped around the wrist of an user according to an embodiment of the present invention.

FIG. 7 displays the shopping and reference list wrapped around the handle of a shopping cart according to another embodiment of the present invention.

### DETAILED DESCRIPTION OF PREFERRED EMBODIMENT

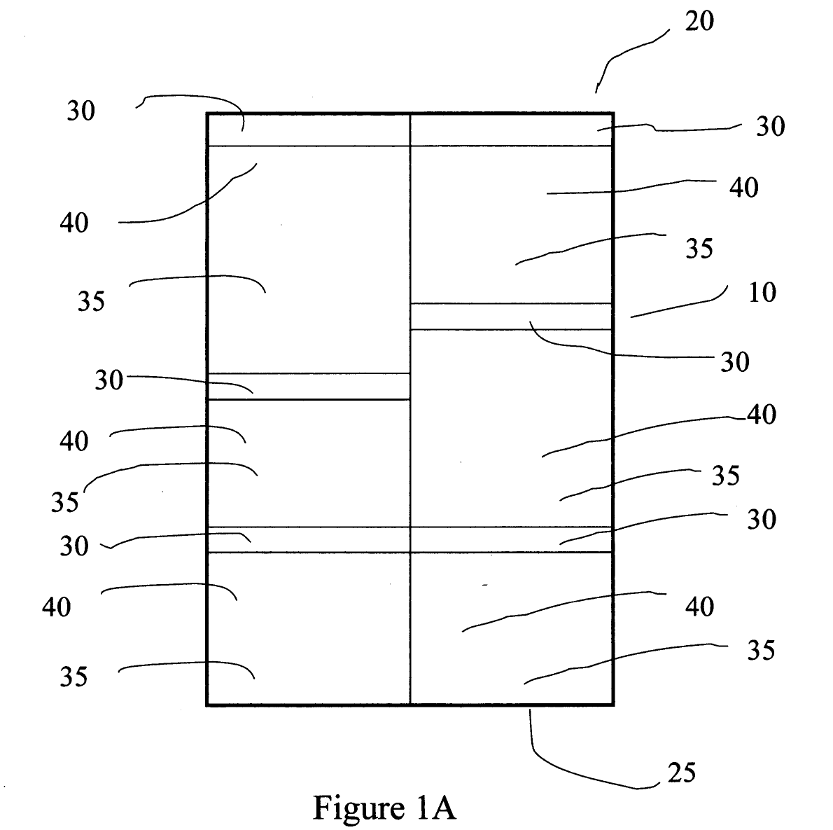

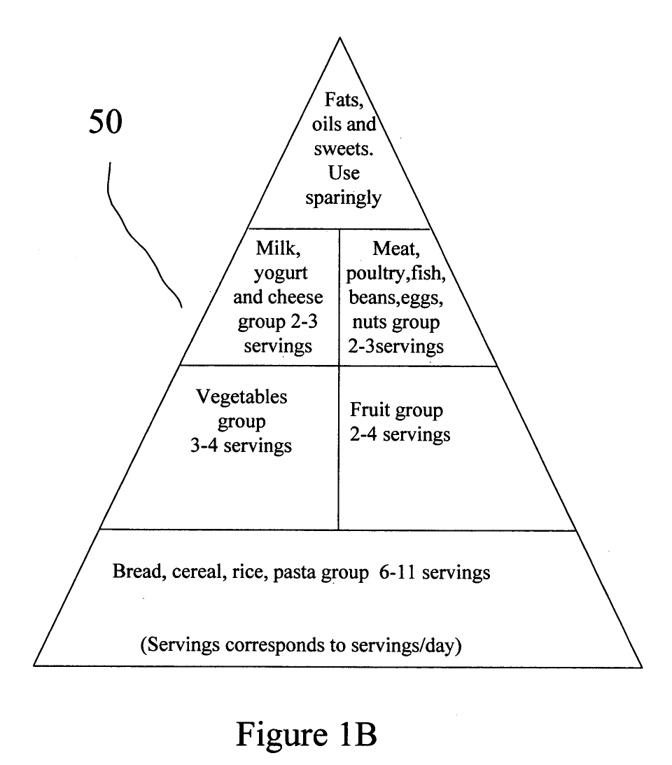

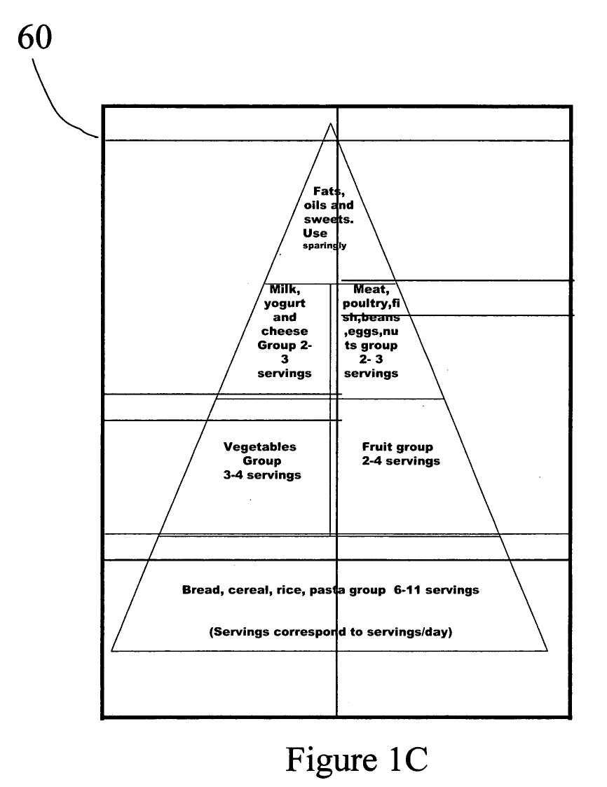

FIG. 1A illustrates the shopping and reference list 10 according to the preferred embodiment of the present invention. The list 10 is made of a sheet of paper such as, for example, a sheet of paper in “Post-It™” pad marketed by Minnesota Mining and Manufacturing Company. Other similar sheets can be equally used for the list 10. The top edge 20 of the list 10 has a pressure sensitive adhesive strip placed on the backside of the list. There is no adhesive placed on the bottom edge 25 of the sheet 10. The invention comprises adequately sized sheets of paper. The front of the paper is pre-printed or pre-formatted and organized in a tabular format where in each cell of the tabular format comprises an insignia or category or heading 30 so as to group items of groceries to be purchased in a manner that they are generally located in a specific isle or area of a grocery store. Each cell or a box on the list also has area or space 35 to make entries or list of items 40 to be purchased that would generally be found within the said group. The insignia can be customized to meet needs of a customer. As discussed before, the backside of each rectangular paper 10 comprises a strip of pressure sensitive adhesive at the top end 20 of the page. The invention comprises plurality of such pages or sheets 10 such that each page 10 is attached to the subsequent page 10 by means of a pressure sensitive adhesive fastener strip applied at the top 20 of each page 10. The last page 10 with pressure sensitive adhesive strip is attached to a plain paper, without any adhesive on the backside of the plain paper. The plain paper can be removed such that the last sheet 10 with the adhesive can be mounted on the refrigerator or other suitable surfaces either by means of pressure sensitive adhesive strip or other means, which are not shown in FIG. 1A, such as magnetic strip or velcro strips or such other mechanical means. The backside of the last sheet 10 can also be used to provide instructions on how to use the shopping and reference list of the present invention or for advertising purposes. The sheet 10 can be customized in the form of a rectangle with dimensions ranging from 1″ to 14″ in length by a suitable width in the range of 1″ to 14″ to fit the needs of the users. Although not shown in FIG. 1A, the list can be configured in various other shapes besides the rectangular shape for wrapping. Examples of category or grouping or heading 30 are produce, dairy, breads/bakery, meats/dinners, breakfast, spices/ethnic, frozen foods, etc. This list 10 can be updated in real time as the need for an item to be purchased is identified, or the items to be purchased can be entered into the list any time prior to or even during shopping.

One skilled in art would appreciate that the format of the list 10 can be adjusted for dimensions as well as number of columns and rows to add additional categories 30 such as pasta/sauces, soda/water, chips/snacks, liquors, canned/soups, kid stuff, soaps/shampoo, cleaning/laundry, paper products, flours/sugar, health/beauty, condiments, miscellaneous, etc. FIG. 1A is an example of the way a list may be formatted. The form and format of list 10 can easily be customized to meet the needs of the user.

In another embodiment of the invention, the list 10 illustrated in FIG. 1A is used as a reference list, for example, for doing errands or for inventory checking and update in a store. The applications for the reference list of the present invention mentioned here are for illustration purposes only, and by no means an exhaustive list, and one skilled in art would realize that there are other applications of such a reference list possible. The reference list 10 comprises a pre-formatted sheet of paper organized in a tabular format on the front side of the sheet of paper wherein each cell of the tabular format comprises a category heading 30 for the items 40 to be referenced and space 35 for listing said items 40 to be referenced under said category. Furthermore, the sheet of paper has placed up on it a strip of pressure sensitive adhesive or glue on the top edge 20 of the back side of said sheet of paper facilitating organizing a plurality of said sheet of paper in the form of a pad and enabling a user in forming a loop of said sheet of paper by attaching said top edge 20 having said adhesive strip to the bottom edge 25 of said sheet of paper while using said sheet of paper for reference. FIG. 1B displays the food pyramid 50. The food pyramid could act as a guide to the user in determining the food groups and the quantities the user should purchase so as to realize the balanced diet. Therefore, in one embodiment of the invention where the list 10 is targeted for grocery shopping, the food pyramid is displayed in the background of the shopping list 60 as illustrated in FIG. 1C.

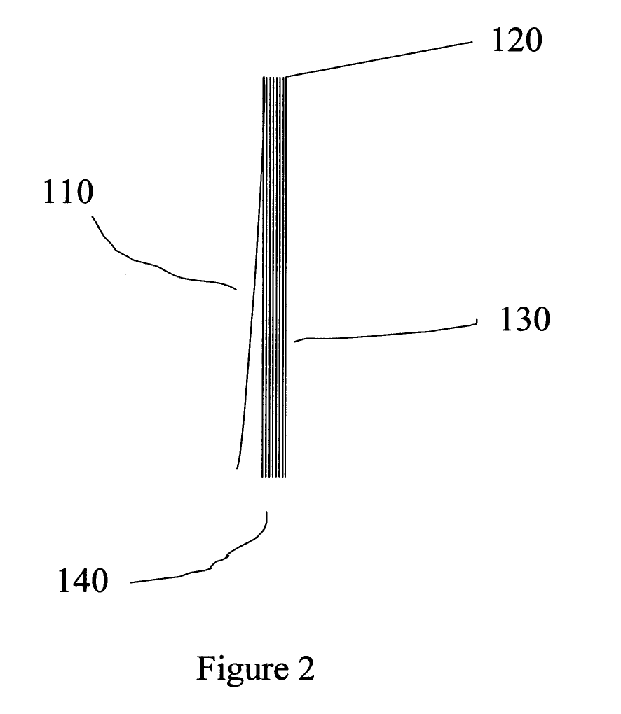

FIG. 2 shows the side view; for example, of the 3M Post It™ Notes pad 140 comprising a plurality of shopping and reference list 110. The last sheet of the glued end 120 at the top, after removal of plain sheet backing 130 can be attached to the surface of a refrigerator, not shown in FIG. 2. The placement of the pad 140 on the refrigerator can also be realized through the use of a magnetic strip or velcro or other such mechanical means, not shown in FIG. 2. This attachment mechanism would depend on the choice of the customer and can be customized accordingly. Number of sheets 110 in the pad 140 can also be customized to meet customer needs. A typical pad 140 can consist of anywhere between 2 and 250 sheets 110.

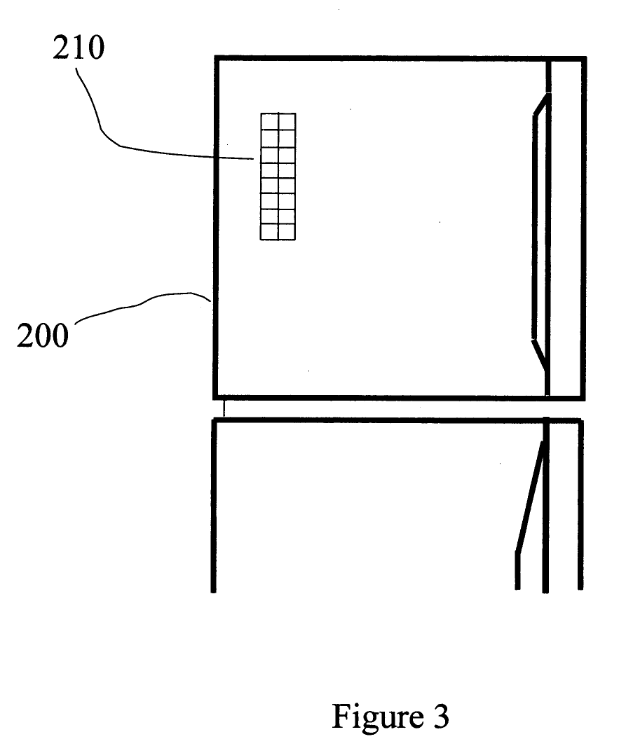

FIG. 3 displays a pad 210 of the shopping and reference list attached to a refrigerator 200. The refrigerator generally provides functionally optimum location for this application. The option to use a magnetic sheet backing can be customized to include a writing instrument.

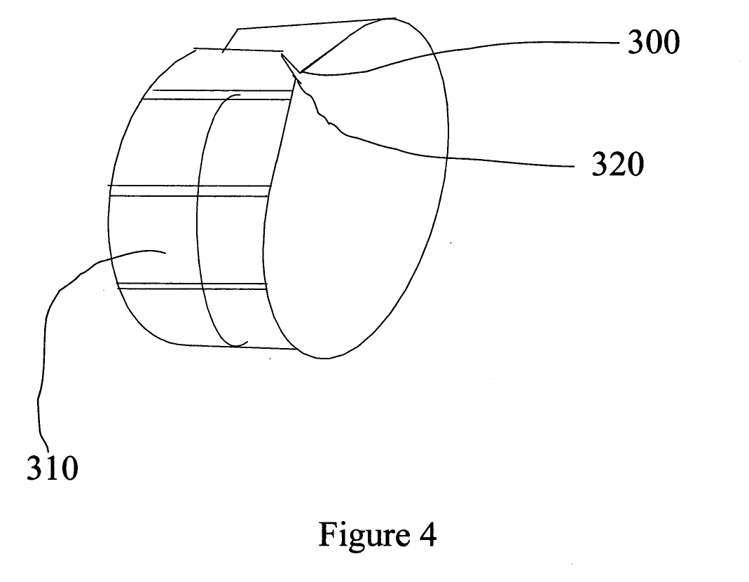

FIG. 4 illustrates the folding mechanism to form a loop of the shopping and reference list according to the preferred embodiment of the present invention. The glued end 320 is attached to the non-glued end or the bottom end 300 on the same side of the sheet. The printed face 310 is shown on the outer side of the loop in FIG. 4. Although not shown in FIG. 4, the attachment to form the loop can be made with other mechanical means as well.

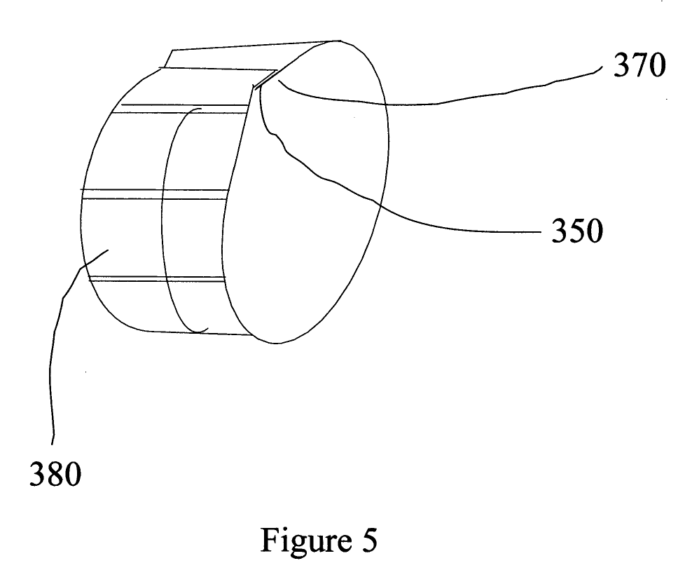

FIG. 5 illustrates another way of forming a loop of the shopping and reference list according to the preferred embodiment of the present invention. Here, the glued end 350 is put over the non-glued end or the bottom end 370 on the opposite side, with printed face 380 showing on the outer side of the loop as shown in FIG. 5. Although not shown in FIG. 5, here again the attachment to form the loop can be made with other mechanical means as well.

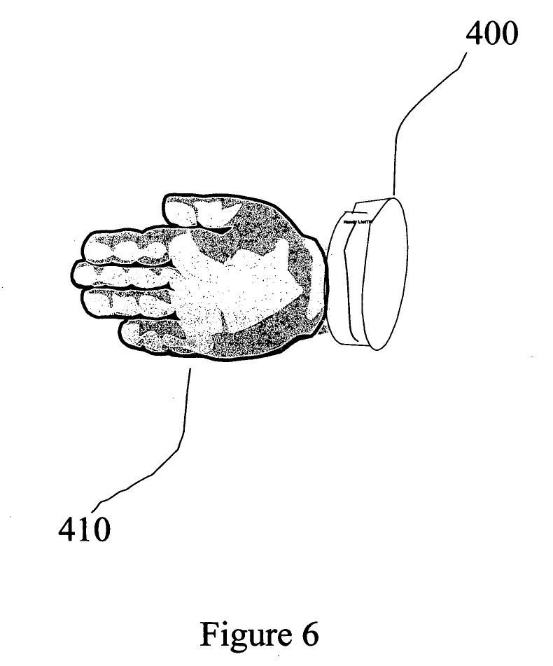

FIG. 6 illustrates the shopping and reference list 400 wrapped around the wrist of a user's hand 410 according to the preferred embodiment of the present invention for ease of referencing while carrying out a task such as shopping for groceries.

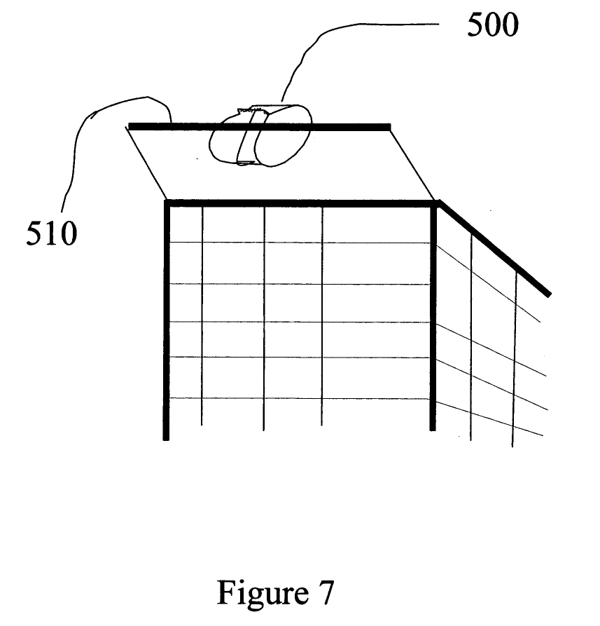

Similarly, FIG. 7 illustrates the shopping and reference list 500 wrapped around the handle 510 of a grocery-shopping cart according to the preferred embodiment of the present invention while shopping for groceries.

We claim:

1. A shopping list apparatus comprising:
a pre-formatted sheet of paper organized in a tabular format on the front side of said sheet of paper wherein each cell of said tabular format comprises a category heading for the items to be purchased and space for listing said items to be purchased under said category; and
wherein said sheet of paper has placed up on it a strip of pressure sensitive adhesive or glue on the top edge of the back side of said sheet of paper facilitating assembling a plurality of said sheet of paper in the form of a pad and enabling a user in forming a loop of said sheet of paper by attaching said top edge having said adhesive strip to the bottom edge of said sheet of paper while shopping.

2. The apparatus of claim 1, wherein a plurality of said sheet of paper are attached together in the form of a pad using said pressure sensitive adhesive applied to said top edge of said back side of each of said sheet of paper.

3. The apparatus of claim 1, wherein a plurality of said sheet of paper are attached together in the form of a pad using said pressure sensitive adhesive applied to said top edge of said back side of each of said sheet of paper, and wherein said pad is placed on a refrigerator or a similar surface.

4. The apparatus of claim 1, wherein said items to be purchased are listed in said space on said sheet of paper by one or more users on a real-time basis as the need arises until the time of shopping whereby creating a completed shopping list, wherein at the time of shopping the user wraps said completed shopping list in the form of a loop around said user's wrist or around the handle of the shopping cart, in a manner such that the front side of the list is on the outer side of the loop, by attaching said top edge with the adhesive to said bottom edge.

5. The apparatus of claim 1, wherein a food pyramid is superimposed on said pre-formatted sheet of paper enabling the user in shopping for a balanced diet.

6. A reference list apparatus comprising:
a pre-formatted sheet of paper organized in a tabular format on the front side of said sheet of paper wherein each cell of said tabular format comprises a category heading for the items to be referenced and space for listing said items to be referenced under said category; and
wherein said sheet of paper has placed up on it a strip of pressure sensitive adhesive or glue on the top edge of the back side of said sheet of paper facilitating organizing a plurality of said sheet of paper in the form of a pad and enabling a user in forming a loop of said sheet of paper by attaching said top edge having said adhesive strip to the bottom edge of said sheet of paper while using said sheet of paper for reference.

7. The apparatus of claim 6, wherein a plurality of said sheet of paper are attached together in the form of a pad using said pressure sensitive adhesive applied to said top edge of said back side of each of said sheet of paper.

8. The apparatus of claim 6, wherein a plurality of said sheet of paper are attached together in the form of a pad using said pressure sensitive adhesive applied to said top edge of said back side of each of said sheet of paper, and wherein said pad is placed on a refrigerator or a similar surface.

9. The apparatus of claim 6, wherein said items to be referenced are listed in said space on said sheet of paper by one or more users on a real-time basis as the need arises until the time of using said sheet of paper for reference whereby creating a completed reference list, wherein at the time of using said reference list the user wraps said completed reference list in the form of a loop around said user's wrist, in a manner such that the front side of the list is on the outer side of the loop, by attaching said top edge with the adhesive to said bottom edge.
